(19) United States
(12) Patent Application Publication
(10) Pub. No.: US 2026/0341867 A1
(43) Pub. Date: Oct. 29, 2026

(54) HUMANOID ROBOT BATTERY

(71) Applicant: Schaeffler Technologies AG & Co. KG, Herzogenaurach (DE)

(72) Inventors: Timothy CHAMBERLAIN, Wellsville, OH (US); Victor Norwich, Wooster, OH (US); Adam Long, Akron, OH (US)

(73) Assignee: Schaeffler Technologies AG & Co. KG, Herzogenaurach (DE)

(21) Appl. No.: 19/533,451

(22) Filed: Feb. 9, 2026

Related U.S. Application Data
(60) Provisional application No. 63/761,152, filed on Feb. 20, 2025.

(51) Int. Cl. H01M 50/213; H01M 10/653; H01M 50/264; H01M 50/276; H01M 50/293; H01M 50/505; H01M 50/519

(52) U.S. Cl. CPC H01M 50/213; H01M 10/653; H01M 50/264; H01M 50/276; H01M 50/293; H01M 50/505; H01M 50/519

(57) ABSTRACT

A battery pack for a humanoid robot including a housing having a cavity, a plurality of cells supported in the cavity of the housing, a cell array secured to the housing and enclosing the cavity, and a cover including a mica sheet secured to the housing over the cell array. The battery pack can include a quick release lock mechanism for securing the battery pack to the humanoid robot.

### CROSS REFERENCE TO RELATED APPLICATIONS

This application claims the benefit of U.S. Provisional Application 63/761,152, filed Feb. 20, 2025 and titled “Humanoid Robot Battery”, which is incorporated by reference as if fully set forth.

### TECHNICAL FIELD

The disclosure relates to a humanoid robots, and more particularly to a humanoid robot battery.

Humanoid robots have been gaining popularity in recent years. Humanoid robots are robots that resemble the human body in shape and include, in general, a torso, a head, two arms, and two legs. Humanoid robots also include rotary actuators, force feedback sensors, and software. Humanoid robots need power to make its motors turn, its sensors operate and the robot’s brain to process information. As such, humanoid robot batteries provide power.

Embodiments according to this disclosure provide a humanoid robot battery that is easily swappable and rechargeable, and provides less robot downtime which creates flexibility.

In accordance with one aspect of the present disclosure, a battery pack for a humanoid robot comprises a housing having a cavity, a plurality of cells supported in the cavity of the housing, a cell array secured to the housing and at least partially enclosing the cavity, and a cover including a mica sheet secured to the housing over the cell array.

The plurality of cells can include cylindrical cells. The plurality of cells can be adhered to the housing with a thermal interface adhesive. The cavity can include a machined bottom surface of the housing. The thermal interface adhesive can be applied between the machined bottom surface and the plurality of cells. The battery pack can further include insulating dividers positioned between the cylindrical cells. The housing can include at least two machined tabs. The machined tabs can be on opposite sides of the cavity. The cell array can support at least one of a circuit board or a bus bar. The cell array can be bonded to the housing with a structural adhesive. The battery pack can further include a quick release locking mechanism for securing the battery pack to the humanoid robot.

In accordance with another aspect of the present disclosure, a method of assembling a battery pack for a humanoid robot comprises providing a housing having a cavity, machining a bottom surface of the cavity, inserting a plurality of cells into a cavity of a housing, applying a thermal interface adhesive between the machined bottom surface and the plurality of cells, securing a cell array to the housing at least partially enclosing the cavity, and securing a cover including a mica sheet to the housing over the cell array.

The plurality of cells can include cylindrical cells. The method can further include positioning insulating dividers between the cylindrical cells. The housing can include at least two machined tabs. The machined tabs can be on opposite sides of the cavity. The cell array can support at least one of a circuit board or a bus bar. The method can further include bonding the cell array to the housing with a structural adhesive. The housing can include a quick release locking mechanism for securing the battery pack to the humanoid robot.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a perspective view of an exemplary battery pack in accordance with the present disclosure.

FIG. 2 is a cross-sectional view of the battery pack of FIG. 1.

FIG. 3 is a cutaway plan view of the battery pack of FIG. 1.

FIG. 4 illustrates the battery pack of FIG. 1 in a first stage of assembly.

FIG. 5 illustrates the battery pack of FIG. 1 in a second stage of assembly.

FIG. 6 illustrates the battery pack of FIG. 1 in a third stage of assembly.

FIG. 7 illustrates the battery pack of FIG. 1 in a fourth stage of assembly.

FIG. 8 illustrates the battery pack of FIG. 1 in a fifth stage of assembly.

FIG. 9 illustrates the battery pack of FIG. 1 in a sixth stage of assembly.

FIG. 10 illustrates the battery pack of FIG. 1 in a seventh stage of assembly.

### DETAILED DESCRIPTION

Certain terminology is used in the following description for convenience only and is not limiting. The words "front," "rear," "upper" and "lower" designate directions in the drawings to which reference is made. The words "inwardly" and "outwardly" refer to directions toward and away from the parts referenced in the drawings. “Axially” refers to a direction along the axis of a shaft. A reference to a list of items that are cited as "at least one of a, b, or c" (where a, b, and c represent the items being listed) means any single one of the items a, b, or c, or combinations thereof. The terminology includes the words specifically noted above, derivatives thereof and words of similar import.

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

Humanoid robots are autonomous systems that need the flexibility to move and operate in a manner similar to humans to provide the required operational flexibility. As such, a flexible power source that provides similar autonomy to that of a power tool battery gives the humanoid robot a similar level of autonomy. The power source disclosed is easily swappable, rechargeable, and more versatile reducing robot downtime creating extra use flexibility.

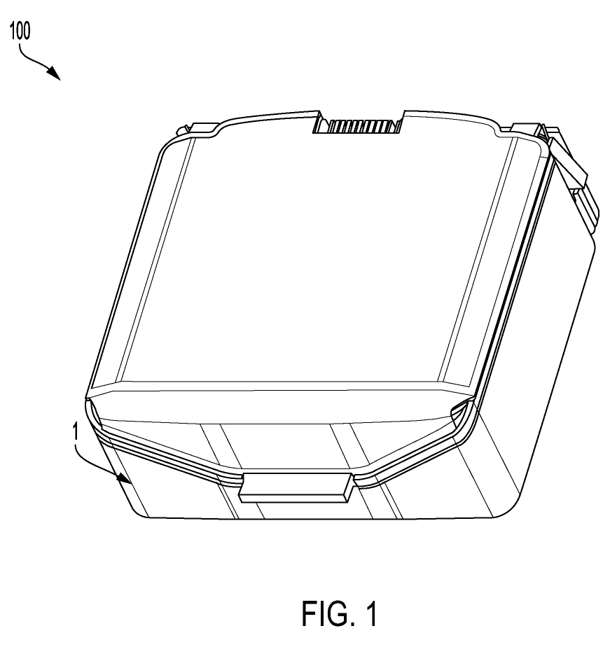

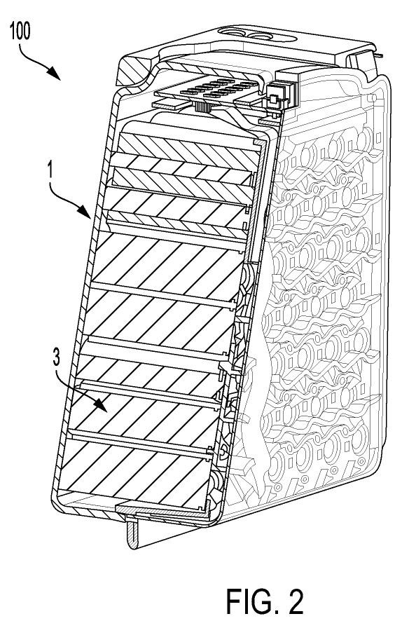

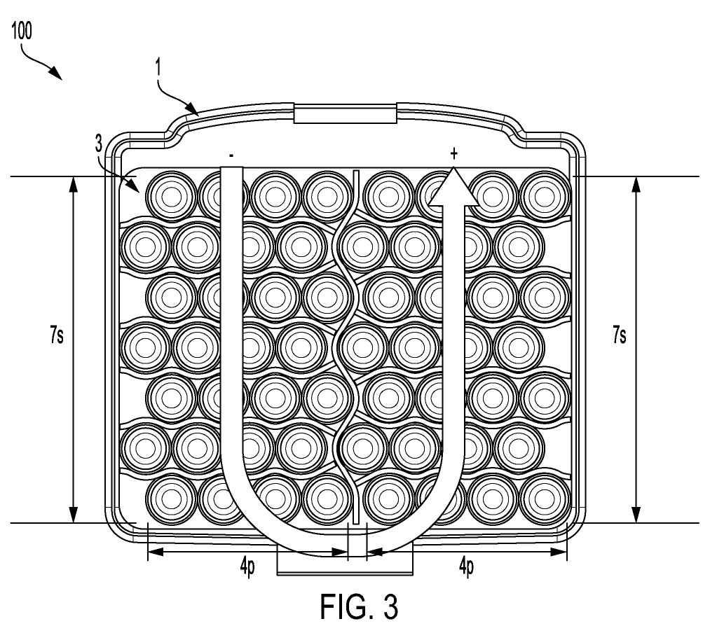

Referring to FIGS. 1-10, and initially to FIGS. 1-3, a battery pack 100 includes multiple cylindrical cells 3 connected in series and parallel. The battery pack 100 is sized for a humanoid's physical constraints, to provide enough power to meet the demand, to have enough energy to have a suitable run time, and to facilitate quick removal and charging without requiring significant robot downtime for charging and/or swapping a charged battery pack 100 into a humanoid robot.

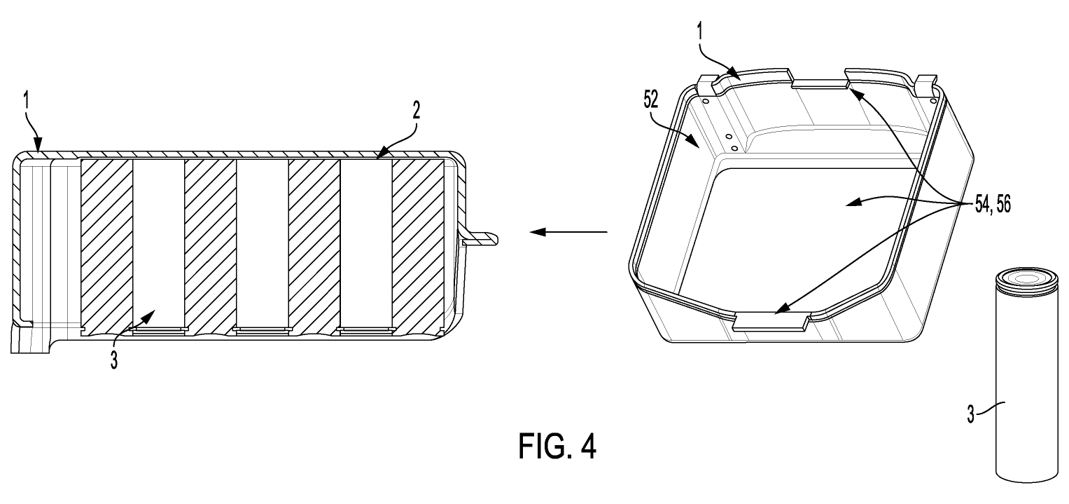

With additional reference to FIG. 4, the battery pack 100 includes a main stamped aluminum housing 1 having a cavity 52 in which the cylindrical cells 3 are received. The housing 1 includes a machined bottom surface 54 and machined tabs 56. The machined bottom surface 54 provides a small tolerance between mating features to ensure a consistent gap between the cells 3 and the machined bottom surface 54 for the thermal interface adhesive 2. The machined tabs 56 ensure engagement with the humanoid robot is consistent and well-controlled, mechanically and electrically during operation. The cylindrical cells 3 are loaded upside down resting on the negative edge within a position locating fixture. The housing 1 is located to the cells b using the same position locating fixture while resting on the machined tabs 56. The cells 3 are adhered to the housing 1 using a thermal interface adhesive 2. The direct bond provides a heat conduction path allowing for active cooling to the outside of the housing 1 during operation.

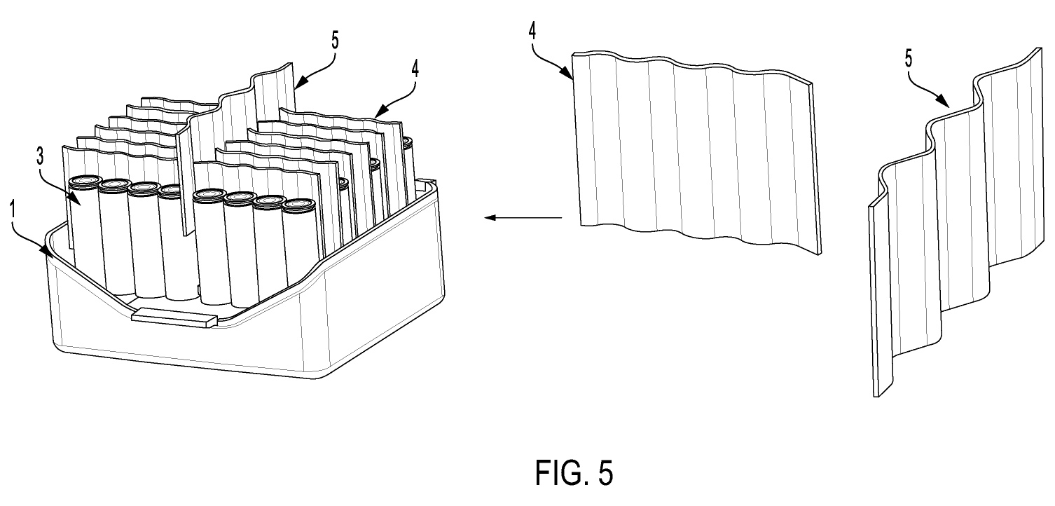

As shown in FIG. 5, after the cells 3 are loaded in the housing 1, the position of the cells is determined by scanning and the housing 1 is turned upright. Insulating dividers 4, 5 are placed between series cell groups to prevent electrical isolation loss and thermal runaway propagation. The insulating dividers in the exemplary embodiment are 2mm formed mica sheets having a wave-like cross-section for meandering between the cylindrical cells 3.

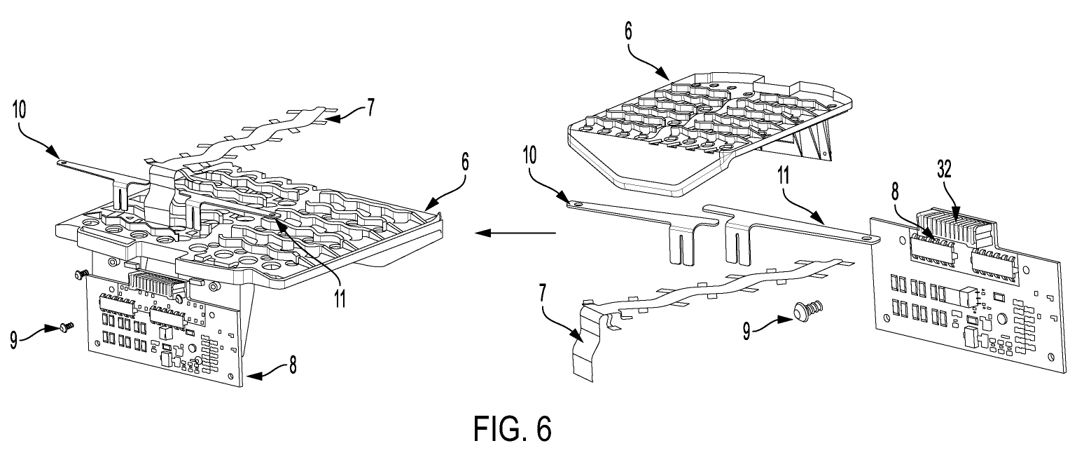

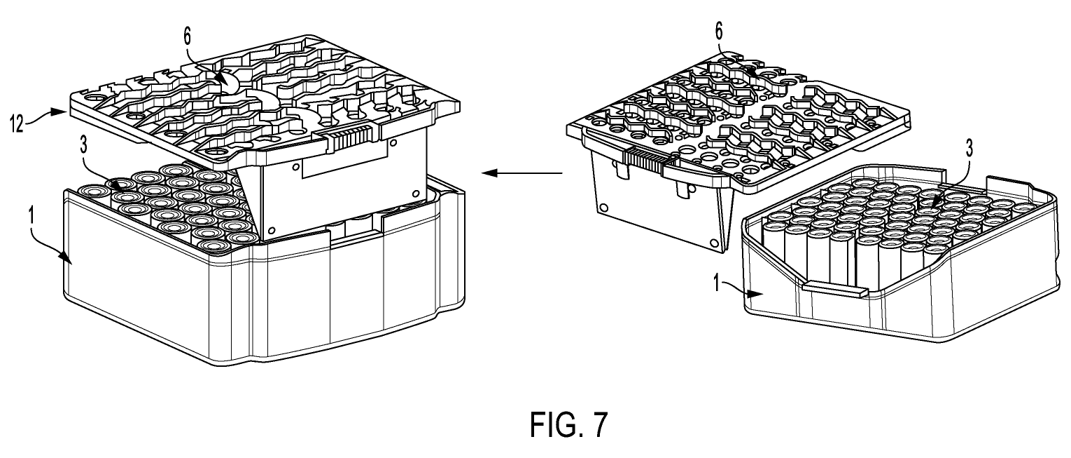

Turning to FIGS. 6 and 7, the top of the housing 1 is sealed and further supported by a cell array 6, which provides multiple functions such as supporting a Flex PCB 7 for cell voltage measurement, balancing, and temperature measurement. The cell array 6 also provides a mount for supporting a rigid PCB 8 which is configured to perform various functions including, for example, cell balancing, temperature data acquisition, communication with the humanoid robot, and main current bussing to an outward facing blind mate connector 32. Power is supplied to the blind mate connector 32 from the cells 3 through two main busses on the positive side 10 and the negative 11 side. The PCB 7 is mounted to the cell array 6 using molding features and fasteners 9, such as self-tapping plastic screws. The cell array 6 is bonded to the aluminum housing 1 via a structural adhesive 12 applied around the perimeter of the housing 1. This provides a complete enclosure sealing the cell array 6 to the housing 1 once joined.

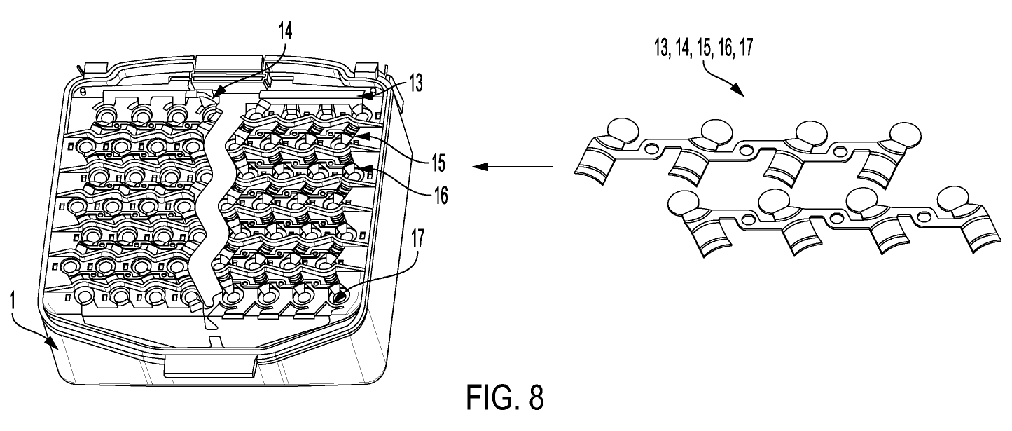

Referring to FIG. 8, cell to cell busbars 13, 14, 15, 16, 17 are then laser welded to the cells 3 and the positive and negative busses 10 and 11 creating the electrical arrangement of fourteen (14) series cell connections and four (4) parallel connections.

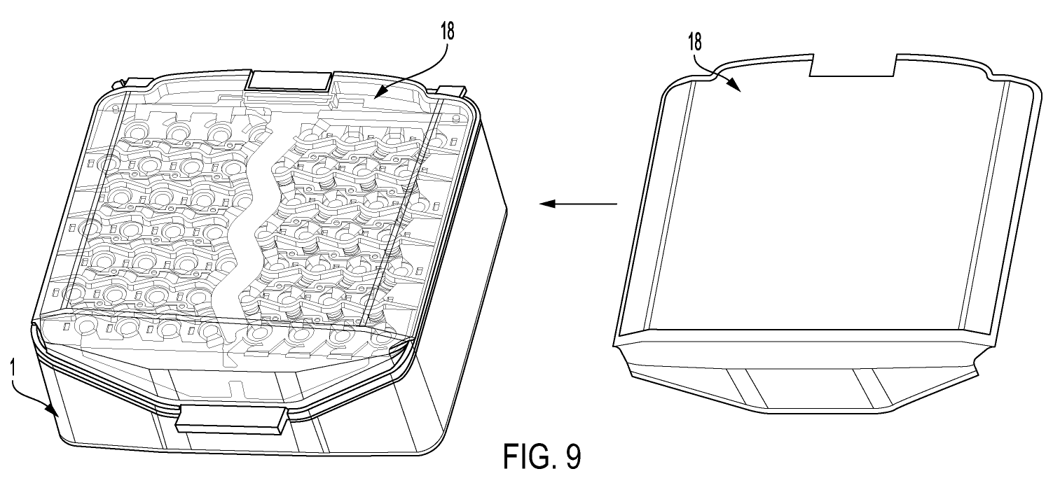

In FIG. 9, a top cover including an insulating mica sheet 18 (e.g., 2mm thick formed mica sheet material) is then applied to the aluminum housing 1 and cell array 6 using a peel and stick adhesive. The insulating mica sheet 18 provides protection for the humanoid robot in the event of a thermal runaway in the form of insulation as well as re-direction of hot gasses out the side of the battery pack 100 and away from the humanoid robot.

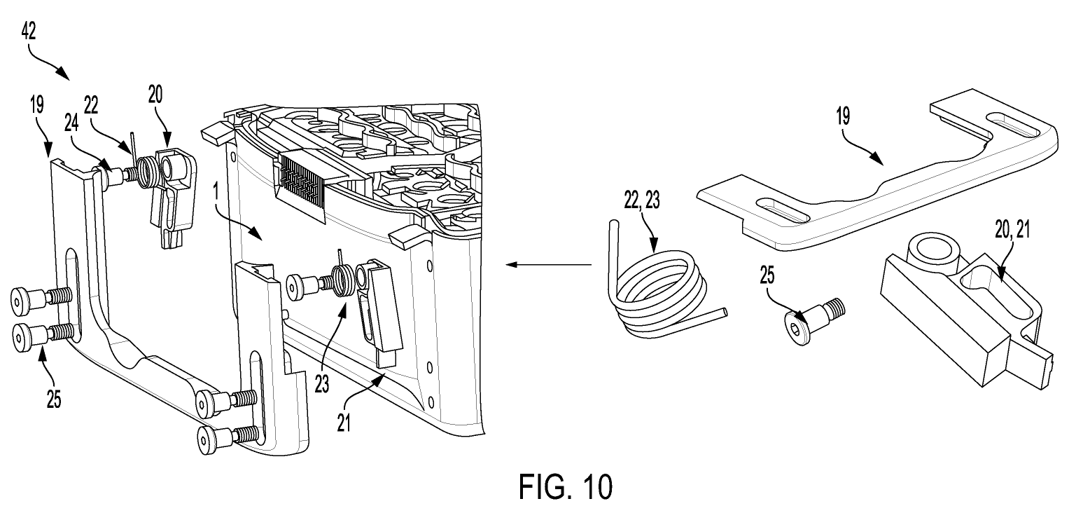

Turning to FIG. 10, the battery pack 100 includes a quick release locking mechanism 42 for securing the battery pack 100 to the humanoid robot. The quick release locking mechanism 42 includes a handle 19, cam locks 20, 21, torsion springs 22, 23, and shoulder bolts 24, 25. The quick release locking mechanism 42 allows an operator or even the humanoid robot to remove the battery pack 100 from the humanoid robot without any special tools or special movements.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

1 housing
2 thermal interface adhesive
3 cylindrical cells
4 come
5 insulating dividers
6 cell array
7 flex PCB
8 rigid PCB
10 bus
11 bus
12 structural adhesive
13 cell-to-cell busbar
14 cell-to-cell busbar
15 cell-to-cell busbar
16 cell-to-cell busbar
17 cell-to-cell busbar
18 insulating mica sheet
19 handle
20 cam lock
21 cam lock
22 torsion spring
23 torsion spring
24 shoulder bolt
25 shoulder bolt
32 blind mate connector
42 quick release locking mechanism
54 machined bottom surface
56 machined tabs
100 battery pack

What is claimed is:

1. A battery pack for a humanoid robot comprising:
a housing having a cavity;
a plurality of cells supported in the cavity of the housing;
a cell array secured to the housing and at least partially enclosing the cavity; and
a cover including a mica sheet secured to the housing over the cell array.

2. The battery pack according to claim 1, wherein the plurality of cells include cylindrical cells.

3. The battery pack according to claim 2, wherein the plurality of cells are adhered to the housing with a thermal interface adhesive.

4. The battery pack according to claim 3, wherein the cavity includes a machined bottom surface of the housing.

5. The battery pack according to claim 4, wherein the thermal interface adhesive is applied between the machined bottom surface and the plurality of cells.

6. The battery pack according to claim 5, further comprising insulating dividers positioned between the cylindrical cells.

7. The battery pack according to claim 6, wherein the housing includes at least two machined tabs.

8. The battery pack according to claim 7, wherein the machined tabs are on opposite sides of the cavity.

9. The battery pack according to claim 1, wherein the cell array supports at least one of a circuit board or a bus bar.

10. The battery pack according to claim 9, wherein the cell array is bonded to the housing with a structural adhesive.

11. The battery pack according to claim 1, further comprising a quick release locking mechanism for securing the battery pack to the humanoid robot.

12. A method of assembling a battery pack for a humanoid robot comprising:
providing a housing having a cavity;
machining a bottom surface of the cavity;
inserting a plurality of cells into a cavity of a housing;
applying a thermal interface adhesive between the machined bottom surface and the plurality of cells;
securing a cell array to the housing at least partially enclosing the cavity; and
securing a cover including a mica sheet to the housing over the cell array.

13. The method according to claim 12, wherein the plurality of cells include cylindrical cells.

14. The method according to claim 13, further comprising positioning insulating dividers between the cylindrical cells.

15. The method according to claim 14, wherein the housing includes at least two machined tabs.

16. The method according to claim 15, wherein the machined tabs are on opposite sides of the cavity.

17. The method according to claim 16, wherein the cell array supports at least one of a circuit board or a bus bar.

18. The method according to claim 17, further comprising bonding the cell array to the housing with a structural adhesive.

19. The method according to claim 12, wherein the housing includes a quick release locking mechanism for securing the battery pack to the humanoid robot.
